(19) United States
(12) Patent Application Publication
(10) Pub. No.: US 2011/0274877 A1
(43) Pub. Date: Nov. 10, 2011

(54) METHOD FOR MANUFACTURING METAL BASE LAMINATE

(76) Inventors: Li-Chih Yu, Tao-Yuan Hsien (TW); Jen-Wen Wang, Tao-Yuan Hsein (TW); Ching-Hsin Ho, Tao-Yuan Hsien (TW); Yi-Wen Weng, Tao-Yuan Hsien (TW)

(21) Appl. No.: 13/098,921

(22) Filed: May 2, 2011

(30) Foreign Application Priority Data
May 4, 2010 (TW) 099114222

(51) Int. Cl. B32B 3/10; B32B 38/04; B32B 37/02

(52) U.S. Cl. 428/138; 156/60; 156/253

(57) ABSTRACT

A method for manufacturing a metal base laminate includes the steps of providing a metal board having a first through-hole; forming a stack-up structure on at least one side of the metal board, wherein a resin film layer, a prepreg layer, and a metal foil layer are disposed in sequence on a metal board-bordered side of the stack-up structure; and laminating the metal board and the stack-up structure together. The method is effective in enhancing mechanical strength, reducing voids which might otherwise be left in through-holes not fully filled in a conventional via filling process, and further enhancing the processing characteristics of the metal base laminate thus manufactured, by using a prepreg and a resin film concurrently as an insulating material. A metal base laminate manufactured by the method is further introduced.

### CROSS-REFERENCE TO RELATED APPLICATION

This non-provisional application claims priority under 35 U.S.C. §119(a) on Patent Application No(s). 099114222 filed in Taiwan, R.O.C. on May 4, 2010, the entire contents of which are hereby incorporated by reference.

### FIELD OF THE INVENTION

The present invention relates to methods for manufacturing metal base laminates, and more particularly, to a method for manufacturing a metal base laminate in a manner effective in reducing voids left in through-holes of a base laminate during a via filling process.

### BACKGROUND OF THE INVENTION

In recent years, the illumination and backlight technology of light-emitting diodes is becoming more sophisticated, and related products have started to prevail. At present, it is well known that light-emitting diodes emit bright light and plenty heat concurrently. As a result, if the heat is not removed from the light-emitting diodes efficiently, the efficiency of light emission of the light-emitting diodes will deteriorate. In this regard, due to its low thermal conductivity, a conventional printed circuit board proves increasingly inadequate to meet the need to dissipate high heat generated from light-emitting diodes mounted on a metal base laminate. Hence, a metal base laminate or a metal-core base laminate is a good option because of its high efficiency of heat dissipation.

In general, a metal base laminate consists essentially of a metal board and is covered thereon with an insulating material and a copper foil in sequence. Also, it can come in the form of a single-sided board or a double-sided board. A conventional method for manufacturing a double-side metal base laminate comprises the steps of drilling, via filling, secondary drilling, and electroplating, and essentially entails forming a first through-hole that penetrates the metal base laminate by a mechanical or laser means, performing via filling with an insulating resin or an insulating conductive resin, drilling a second through-hole of a smaller diameter after the resin has been baked and cured, and eventually filling the second through-hole with an electrically conductive material or with a conductive layer formed by electroplating, so as to effectuate connection of a double-sided conductive wiring.

As described above, the conventional via filling process most often involves filling through-holes with a via-fill paste. However, since through-holes are of a relatively large diameter and manifest the capillary phenomenon to a relatively less extent, the conventional via filling process has a drawback: a portion of the via-fill paste flows out of the through-holes while being baked and cured; as a result, the through-holes are not fully filled, thereby causing formation of voids or recesses during a subsequent process to the detriment of the reliability and quality of the circuit boards thus manufactured.

To reduce the formation of voids, the related prior art teaches using a prepreg or a resin film in conjunction with a copper foil or teaches performing the via filling process with a resin coated copper (RCC) foil by lamination. However, the results of the conventional via filling processes are still unsatisfactory.

In the conventional via filling process that involves the use of a prepreg, the prepreg is disposed on the upper and lower sides of a metal board, and then a copper foil is disposed on the outer sides of the prepreg. Finally, the aforesaid layers are laminated together at a vacuum, a high temperature, and a high pressure, such that the resin of the prepreg fills the through-holes of the metal board. However, the prepreg usually comes in the form of a glass fabric impregnated with resin. The glass fabric is of a high density and the prepreg has a resin content of 40˜80% only, and thus the through-holes in the metal board cannot be fully filled. Furthermore, resin fails to flow when impeded by the glass fabric, and thus voids are left in the resin which does not fill the through-holes fully.

In a conventional via filling process that uses a resin coated copper (RCC) foil, a resin-coated RCC foil which is disposed on the upper and lower sides of the metal board substitutes for the prepreg and the copper foil, and then the resin-coated RCC foil and the metal board are laminated together to enable the resin of the RCC foil to fill the through-holes of the metal board. However, the conventional via filling process has the same result as the prepreg technique does, that is, causing voids to be present in the through-holes.

In a conventional via filling process that uses a resin film, the resin film is adapted to replace the prepreg and disposed on the upper and lower sides of the metal board, and then the copper foil, the resin film, and the metal board are laminated together. However, with the resin film being deficient in fiber material, the following occurs: the resultant laminate is not provided with sufficient support; a plurality of voids is present in the resin layer in the through-hole structure; a plurality of recesses is present in the copper foil and the resin layer above and below the through-hole structure; and, as a result, the resultant low surface flatness compromises the conforming rate of a subsequent wiring process.

### SUMMARY OF THE INVENTION

In view of the aforesaid shortcomings of the prior art, it is imperative to provide a method for manufacturing a metal base laminate in a manner effective in enhancing mechanical strength, reducing voids or recesses formed in a resin layer in through-holes, and further enhancing the electrical and processing characteristics of the metal base laminate thus manufactured.

It is a primary objective of the present invention to provide a method for manufacturing a metal base laminate in a manner effective in enhancing mechanical strength and reducing voids formed in resin in through-holes by using a prepreg and a resin film concurrently as an insulating material.

In order to achieve the above and other objectives, the present invention provides a method for manufacturing a metal base laminate. The method comprises: (1) providing a metal board having a first through-hole; (2) forming a stack-up structure on at least one side of the metal board, wherein a resin film layer, a prepreg layer, and a metal foil layer are disposed in sequence on a metal board-bordered side of the stack-up structure; and (3) laminating the metal board and the stack-up structure together.

The present invention further provides a metal base laminate comprising a metal board and a stack-up structure formed on the metal board. The metal board has a first through-hole. A resin film layer, a prepreg layer, and a metal foil layer are disposed in sequence on a metal board-bordered side of the stack-up structure.

Regarding the aforesaid method or metal base laminate, a prepreg is obtained by impregnating an insulating paper, glass fiber, carbon fiber, or any other fiber material with the resin composition (varnish) and then performing a baking and heating process thereon.

Regarding the aforesaid method or metal base laminate, the resin film is obtained by applying a resin to a release film (such as PET), heating the resin-coated release film to form a semi-cured resin-coated release film, and removing the release film. The resin film thus obtained is different from the prepreg mainly in that the resin film does not contain any fiber material. The resin composition material of the prepreg and the resin film is one selected from the group consisting of epoxy resin, phenolic resin, polyimide resin, polyphenylene ether resin, polyester resin, cyanate ester resin, polytetrafluoroethylene (PTFE) resin, Ajinomoto build-up film (ABF), and bismaleimide triazine (BT) resin, or a combination thereof.

To increase the thermal conductivity of the prepreg and the resin film, the resin composition further comprises an inorganic filler. The inorganic filler is at least one selected from the group consisting of silicon dioxide (SiO₂) (molten or non-molten), alumina, magnesium oxide (MgO), magnesium hydroxide (Mg(OH)₂), calcium carbonate (CaCO₃), talc, clay, aluminum nitride (AlN), boron nitride (BN), aluminum hydroxide (Al(OH)₃), aluminum silicon carbide (AlSiC), silicon carbide (SiC), sodium carbonate (Na₂CO₃), titanium dioxide (TiO₂), zinc oxide (ZnO), zirconium oxide (ZrO₂), quartz, diamond powder, diamond-like powder, graphite, and calcined kaolinite, or is a combination thereof. With the inorganic filler being of a thermal conductivity higher than that of a resin material, the thermal conductivity of the resin composition is effectively increased. The resin composition further comprises an additive, such as a surfactant, a toughening agent, a curing promoter, or a solvent.

Regarding the aforesaid method or the metal base laminate, the metal board is made of copper, aluminum, stainless steel, magnesium, nickel, titanium, or an alloy thereof, and the metal foil layer comprises a copper foil.

Regarding the aforesaid method or the metal base laminate, the first through-hole is of a diameter ranging between 0.4 and 1.6 mm, and the metal base laminate is 0.3 to 3 mm thick.

Preferably and selectively, the aforesaid method further comprises the steps of: forming a second through-hole penetrating the stack-up structure and the metal board and being of a diameter less than the first through-hole; forming a metal conductive layer in the second through-hole; and fabricating a wiring from the metal foil layer.

The second through-hole is formed by mechanical drilling or laser drilling. The metal conductive layer is formed by electroplating. The wiring is formed by a photolithography process.

Accordingly, a method for manufacturing a metal base laminate according to the present invention is effective in enhancing mechanical strength, reducing voids formed in resin in through-holes, and further enhancing the processing conforming rate of the metal base laminate in a printed circuit board manufacturing process by using a prepreg and a resin film concurrently as an insulating material.

### BRIEF DESCRIPTION OF THE DRAWINGS

Objectives, features, and advantages of the present invention are hereunder illustrated with specific embodiments in conjunction with the accompanying drawings, in which:

FIG. 1A through FIG. 1F are cross-sectional views of a structure involved in a method for manufacturing a metal base laminate according to an embodiment of the present invention;

FIG. 2A is a cross-sectional view of a structure involved in the prior art; and

FIG. 2B is a cross-sectional view of a structure involved in a method for manufacturing a metal base laminate according to an embodiment of the present invention.

### DETAILED DESCRIPTION OF THE PREFERRED EMBODIMENTS

According to the present invention, a metal base laminate is a structure that results from lamination of a metal board to an insulating material and a metal foil layer which cover the metal board in sequence. Hence, both a metal-core laminate and a metal-core PCB are aspects of the metal base laminate of the present invention, though the present invention is not limited thereto. The metal board is made of a metal, such as aluminum, copper, stainless steel, magnesium, nickel, or titanium, or an alloy thereof. According to the present invention, a through-hole is a hole that penetrates another structure and comes in the form of a blind via or a buried via as needed, depending on a process.

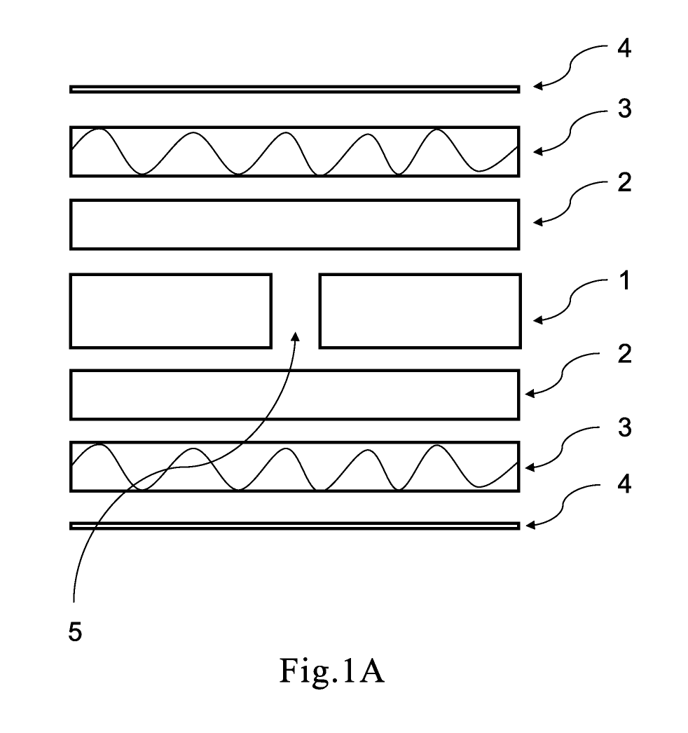

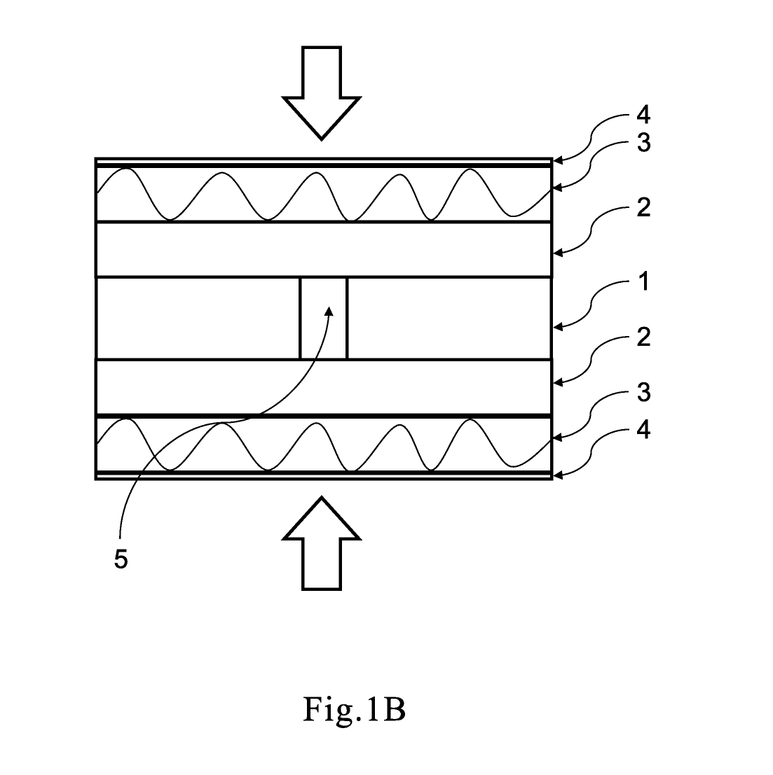

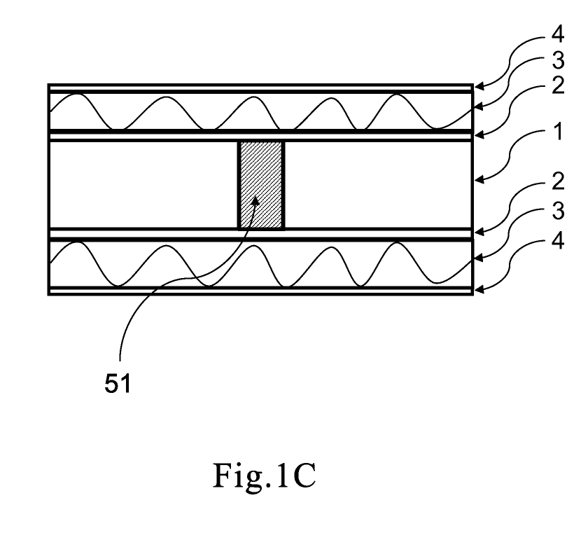

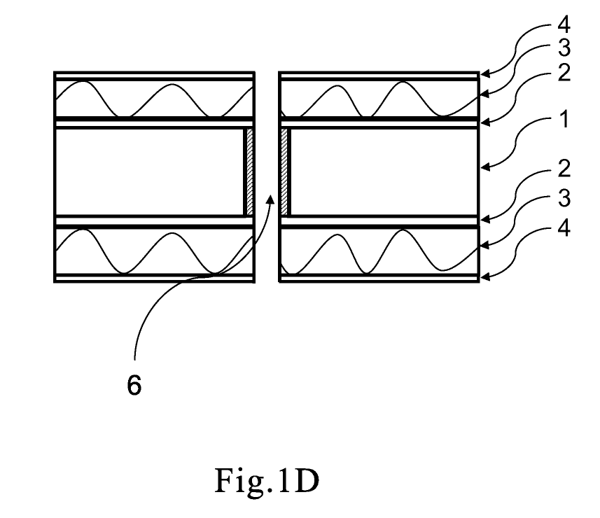

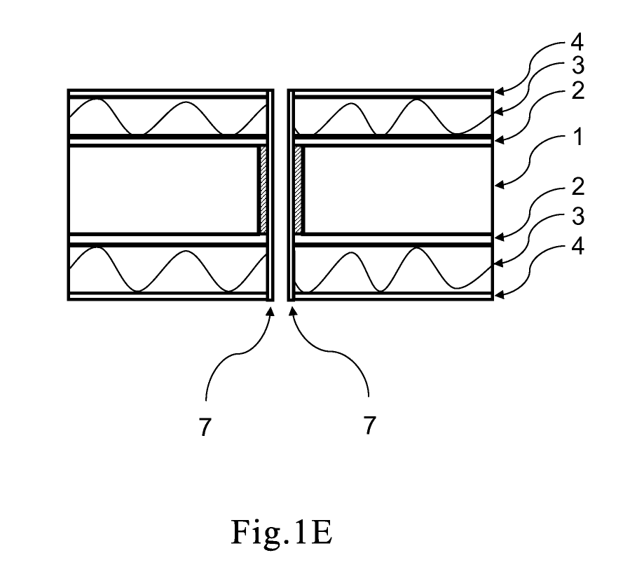

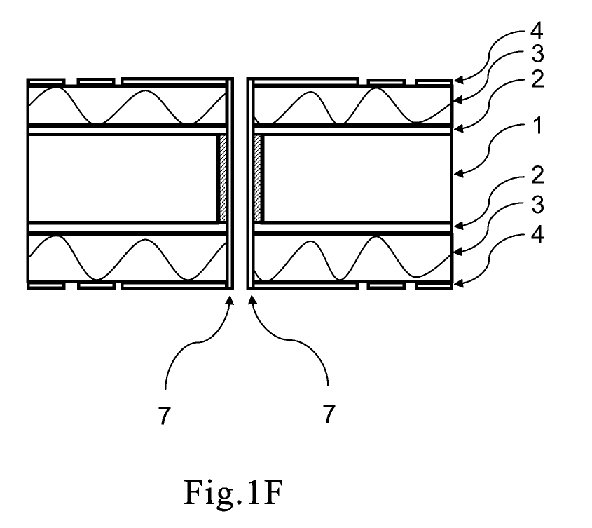

Referring to FIG. 1A through FIG. 1F, there are shown cross-sectional views of a structure involved in the steps of a method for manufacturing a metal base laminate according to a preferred embodiment of the present invention.

As shown in FIG. 1A, a metal board 1 having a first through-hole 5 is provided. The first through-hole 5 is of a diameter that ranges between 0.4 and 1.6 mm. The metal board 1 is made of a metal, such as aluminum, copper, stainless steel, magnesium, nickel, or titanium, an alloy thereof, or any metal core applicable to a metal-core PCB. A resin film 2, a prepreg 3, and a copper foil 4 are disposed on the upper and lower sides of the metal board 1 in sequence.

The resin composition material of the resin film 2 is one selected from the group consisting of epoxy resin, phenolic resin, polyimide resin, polyphenylene ether resin, polyester resin, cyanate ester resin, polytetrafluoroethylene (PTFE) resin, Ajinomoto build-up film (ABF), and bismaleimide triazine (BT) resin, or a combination thereof.

The prepreg 3 is obtained by impregnating an insulating paper, glass fiber, carbon fiber, or any other fiber material with the resin composition and then performing a baking and heating process thereon. The resin composition material for use in impregnation is the same as or different from the material of the resin film 2.

FIG. 1B shows the condition of each layer structure before lamination, including the metal board 1 and a stack-up structure. The stack-up structure comprises the resin film layer 2, the prepreg layer 3, and the copper foil layer 4. At a vacuum, a high temperature, and a high pressure, the metal board 1 and the stack-up structure are laminated together to form the metal base laminate as shown in FIG. 1C.

In addition, according to the present invention, it is feasible to perform repeatedly the step of providing the metal board and the stack-up structure so as to form a multilayer circuit board. To laminate the metal board 1 and the stack-up structure together, it is feasible to fill the first through-hole 5 with resin of the prepreg 3 and/or the resin film 2. The lamination takes place at 70° C.˜300° C., a temperature rising rate larger than 2° C./min, and a pressure above 20 kg/cm².

FIG. 1C shows the condition of each layer structure after lamination thereof has been performed at a vacuum, a high temperature, and a high pressure. The purpose of the high temperature is to heat up the prepreg 3 and/or the resin film 2, such that the resin thereof is liquefied and manifests fluidity, thereby allowing the first through-hole to be filled with the liquefied fluid resin. Upon completion of lamination, the resin of the prepreg 3 and/or the resin film 2 has already filled the first through-hole in part or in whole to thereby form a resin layer 51 in the through-hole structure.

FIG. 1D shows a step of fabricating a second through-hole 6, wherein the second through-hole 6 is of a diameter less than that of the first through-hole, and the step of fabricating the second through-hole 6 is performed by mechanical drilling or laser drilling.

FIG. 1E shows how to effectuate the electrical connection of the upper and lower circuits by electroplating a metal conductive layer 7 on the wall of the second through-hole 6.

FIG. 1F shows how to fabricate an electrically conductive wiring on the copper foil layer 4 by a photolithography process, that is, removing a portion of a copper wiring by etching, such that the remaining portion of the copper wiring forms the intended wiring.

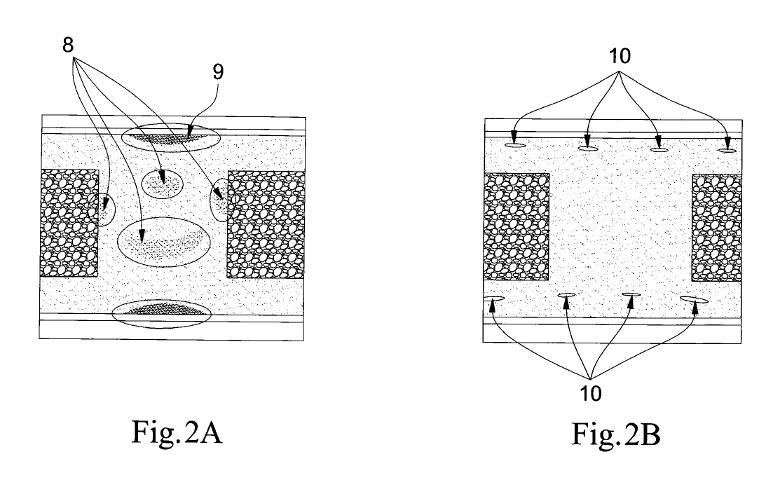

Referring to FIG. 2A, there is shown a cross-sectional view of a structure involved in the prior art. The prior art teaches using a resin film as an insulating material of a laminate. With the resin film being deficient in fiber material, the following occurs: the resultant laminate is not provided with sufficient support; a plurality of voids 8 is present in the resin layer in the through-hole structure; a plurality of recesses 9 is present in the copper foil and the resin layer above and below the through-hole structure; and, as a result, the resultant low surface flatness compromises the conforming rate of a subsequent wiring process. In another aspect, FIG. 2B is a cross-sectional view of a structure involved in a method for manufacturing a metal base laminate according to a preferred embodiment of the present invention, wherein a glass fabric 10 is defined by the shadowed areas. As shown in FIG. 2B, a method for manufacturing a metal base laminate according to the present invention is effective in greatly reducing voids and recesses which might otherwise be formed in through-hole structures as disclosed in the prior art, enhancing mechanical strength, and further enhancing the processing conforming rate of a printed circuit of a metal base laminate, by using a prepreg and a resin film concurrently as an insulating material of a laminate.

Hence, the present invention meets the three requirements of patentability, namely novelty, non-obviousness, and industrial applicability. Regarding novelty and non-obviousness, the present invention discloses enhancing mechanical strength, reducing voids formed in a resin layer in a through-hole structure, and further enhancing the processing conforming rate of a printed circuit of a metal base laminate, by using a prepreg and a resin film concurrently as an insulating material of a metal base laminate. Regarding industrial applicability, products derived from the present invention meet existing market demands fully.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A method for manufacturing a metal base laminate, the method comprising the steps of:
providing a metal board having a first through-hole;
forming a stack-up structure on at least one side of the metal board, wherein a resin film layer, a prepreg layer, and a metal foil layer are disposed in sequence on a metal board-bordered side of the stack-up structure; and
laminating the metal board and the stack-up structure together.

2. The method of claim 1, wherein the metal board is made of one selected from the group consisting of copper, aluminum, stainless steel, magnesium, nickel, titanium, and an alloy thereof, and the metal foil layer comprises a copper foil.

3. The method of claim 1, further comprising the step of forming a second through-hole penetrating the stack-up structure and the metal board and being of a diameter less than the first through-hole.

4. The method of claim 3, further comprising the step of forming a metal conductive layer in the second through-hole.

5. The method of claim 4, further comprising the step of fabricating a wiring from the metal foil layer.

6. A metal base laminate comprising a metal board and a stack-up structure formed on the metal board, the metal board having a first through-hole therein, wherein a resin film layer, a prepreg layer, and a metal foil layer are disposed in sequence on a metal board-bordered side of the stack-up structure.

7. The metal base laminate of claim 6, wherein the metal board is made of one selected from the group consisting of copper, aluminum, stainless steel, magnesium, nickel, titanium, and an alloy thereof, and the metal foil layer comprises a copper foil.

8. The metal base laminate of claim 6, wherein at least a portion of the first through-hole is filled with resin of the resin film layer.

9. The metal base laminate of claim 8, further comprising a second through-hole penetrating the resin in the first through-hole and the stack-up structure.

10. The metal base laminate of claim 9, wherein a wall of the second through-hole is covered with an electrically conductive material.

11. The metal base laminate of claim 6, wherein the metal foil layer comprises a wiring.
